(19) United States
(12) Patent Application Publication
(10) Pub. No.: US 2007/0216869 A1
(43) Pub. Date: Sep. 20, 2007

(54) Projection type image display apparatus

(76) Inventors: Junko Kawase, Tokyo (JP); Masahiko Yatsu, Fujisawa (JP); Fukuyasu Abe, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/513,370

(22) Filed: Aug. 31, 2006

(30) Foreign Application Priority Data
Mar. 16, 2006 (JP) 2006-071941

(51) Int. Cl. G03B 21/14

(52) U.S. Cl. 353/20; 349/9

(57) ABSTRACT

A high-luminance projection type image display apparatus is realized by improving a conventional polarization converter unit. Light-beam split means 21 for splitting light from a light source is arranged before a polarization converter unit 960 having a plurality of incidence surfaces, and the light coming from the polarization converter unit 960 enters a rod integrator 24.

### BACKGROUND OF THE INVENTION

The present invention relates to a projection type image display apparatus which projects an image on a screen by use of a liquid crystal panel as an image display element, such as a liquid crystal projector apparatus, a reflection type image display projector apparatus, and a projection type rear-projection TV. More particularly, the present invention is concerned with an integrator optical system and polarization conversion technology.

With a projection type image display apparatus, it is desirable that the luminance distribution (light volume distribution) of a projected picture be substantially uniform. When using a liquid crystal panel as an image display element, it is necessary to irradiate the liquid crystal panel with linearly-polarized light which is uniformly polarized in a predetermined polarizing direction. Therefore, this type of apparatus has conventionally been using an optical system (hereafter referred to as “polarization converter unit”) comprising in combination a lens-arrayed integrator optical system, a polarization beam splitter array, and a condenser lens. The lens-arrayed integrator optical system includes first and second lens arrays which make uniform the light volume distribution of the light emitted from a light source. The polarization beam splitter array aligns the polarizing direction of illumination light, made uniform by the integrator optical system, in that of predetermined linearly-polarized light. Alternatively, a polarization converter unit, an optical system combining a polarization conversion element with a rod integrator, is used. An example of projection type image display apparatus having a polarization converter unit of this type is shown in FIG. 9 and FIG. 1 of JPA2003-57602.

When a polarization converter unit including a lens-arrayed integrator optical system and a polarization conversion element of a polarization beam splitter array, shown in FIG. 9 of JPA2003-57602, is used, an image of each lens cell of the first lens array is imaged on an illumination section of the image display element through the second lens array and a downstream condenser lens. Specifically, the unit is designed so that the shape of each lens cell of the first lens array is analogous to that of the image display element. The polarization conversion element includes a light mask, a polarization beam splitter array, and a λ/2 phase-difference plate.

A polarization converter unit combining a rod integrator system with a polarization conversion element, shown in FIG. 1 of JPA2003-57602, includes a rod integrator which makes light uniform and, on the incidence surface side of the rod integrator, a polarization conversion element including a polarization split prism having polarization split action, a reflecting prism, and a λ/2 phase-difference plate arranged in contact with the reflecting prism.

### SUMMARY OF THE INVENTION

However, with the combination of the above-mentioned lens-arrayed integrator optical system and the polarization conversion element of the polarization beam splitter array, an image of each lens cell of the first lens array is imaged on the image display element through the second lens array and a condenser lens. Therefore, the shape of each lens cell must be analogous to that of the image display element. Furthermore, it is necessary that a partial light beam coming from each lens cell of the first lens array passes through an opening section of the light mask and then condenses in the polarization conversion element.

It is difficult to satisfy these two conditions at the same time with the above-mentioned configuration. With the above-mentioned conventional technology, therefore, it is necessary to optimize the shape of each lens cell of the first lens array so that as large quantity as possible of each partial light beam exiting from each lens cell passes through the opening section of the light mask in order to improve the utilization efficiency of light.

An image of each lens cell of the first lens array is imaged on the image display element through each lens cell of the second lens array and the condenser lens. Therefore, the center of the image of each lens cell of the first lens array, imaged on the image display element, is shifted because of the variation in shape of the lens cell of the first and second lens arrays, resulting in the variation of image. For imaging on the image display element, therefore, it is necessary to manage the shape of each lens cell of the first and second lens arrays with a high accuracy, arising a problem of cost increase.

On the other hand, in the case of a polarization converter unit using a rod integrator, shown in FIG. 1 of JPA2003-57602, the light beam entering a polarization split prism from a light source (not shown) is condensed, for example, at the incidence-side end face of the polarization split prism arranged near the secondary focus of an ellipse reflector of the light source. This causes a temperature rise at the polarization split prism, which disturbs the polarization split characteristic and causes a problem of degraded polarization conversion efficiency.

Generally with an illumination optical system, a spatial extent wherein light beam which can be effectively treated is present can be represented as a product of the area and solid angle (referred to as etendue: Geometrical Extent). The product of the area and solid angle is conserved in an optical system. When this law is applied, the solid angle of incident light beam becomes large because of a small condensing area of the incident light beam entering a polarization split prism, i.e., the angle of incident light with respect to the optical axis becomes large. Therefore, the angle of incident light entering the polarization split prism from a light source becomes large. Generally, the characteristic of a polarization conversion element depends on the incident angle of light, i.e., the polarization conversion characteristic deteriorates with increasing incident angle. Specifically with the conventional technology, there are cases where the polarization conversion efficiency deteriorates because of a large incident angle to the polarization conversion element. Thus, in a polarization converter unit using a rod integrator, the polarization conversion efficiency deteriorates and accordingly the ratio of desired P-polarized light contained in the light coming from the polarization converter unit decreases, resulting in the degradation of the utilization efficiency of light which can be utilized by subsequent optical systems (not shown).

An object of the present invention is to improve the utilization efficiency of light or provide a polarization converter unit for a projection type image display apparatus which enables high luminance of images.

According to an aspect of the present invention, light-beam split means for splitting the light from a light source is arranged in front of the polarization converter unit having a plurality of incidence surfaces, and the light coming from the polarization converter unit enters a rod integrator. According to another aspect of the present invention, the shape of the light-exiting surface of the rod integrator is analogous to that of a liquid crystal display element.

### BRIEF DESCRIPTION OF THE DRAWINGS

FIG. 1 is a block diagram showing a principal part of a polarization converter unit.

FIG. 2 is a diagram showing a configuration of a projection type image display apparatus.

FIG. 3 A-C is a diagram showing a configuration of a color wheel.

FIG. 4 is a block diagram of light-beam split means.

FIG. 5 is a lighting diagram illustrating the condensing action of the polarization converter unit.

FIG. 6 is a block diagram of a principal part of a polarization converter unit.

FIG. 7 is a diagram showing another configuration of a polarization converter unit.

FIG. 8 is a diagram showing still another configuration of a polarization converter unit.

FIG. 9 is a diagram showing another configuration of a projection type image display apparatus.

FIG. 10 is a diagram showing still another configuration of a projection type image display apparatus.

FIG. 11 is a diagram showing still another configuration of a projection type image display apparatus.

### DETAILED DESCRIPTION OF PREFERRED EMBODIMENT

An embodiment of the present invention will be described below with reference to the accompanying drawings. In each drawing, the same symbols are assigned to elements having a common function and duplicated explanations are omitted.

A polarization converter unit will be described in details in some embodiments below. Unpolarized light without polarization emitted from a light source is split into a plurality of partial light beams, followed by polarization conversion. Then the light volume distribution of the resulting light beams is made uniform by a rod integrator. The polarization converter unit refers to an optical system which makes uniform the light volume distribution of the light emitted from the light source and converts the light to predetermined polarized light.

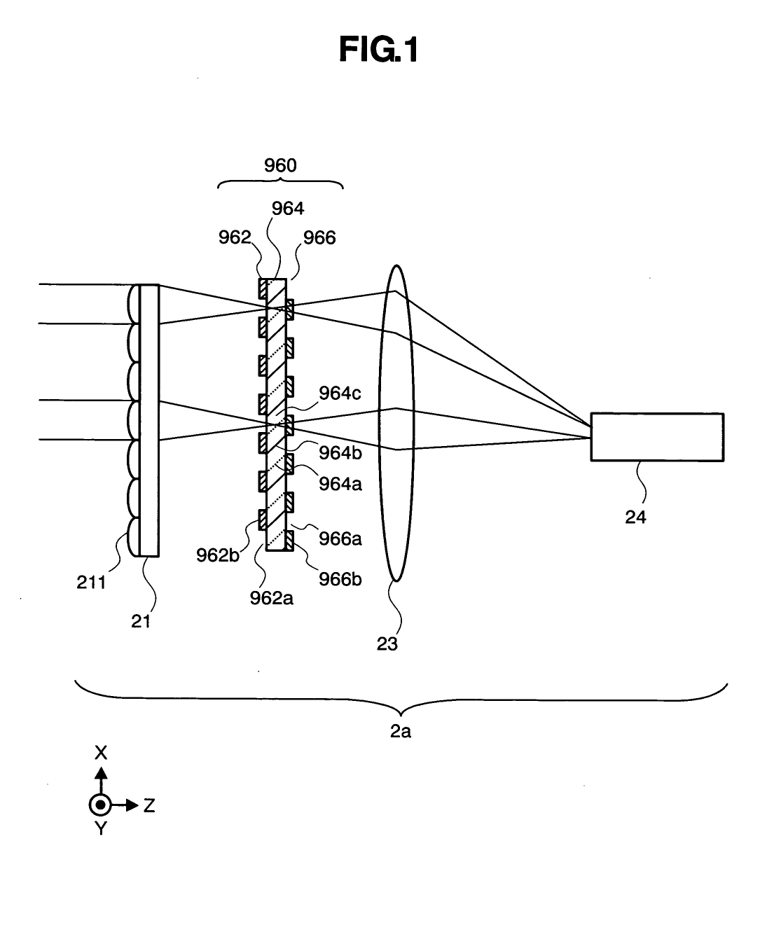

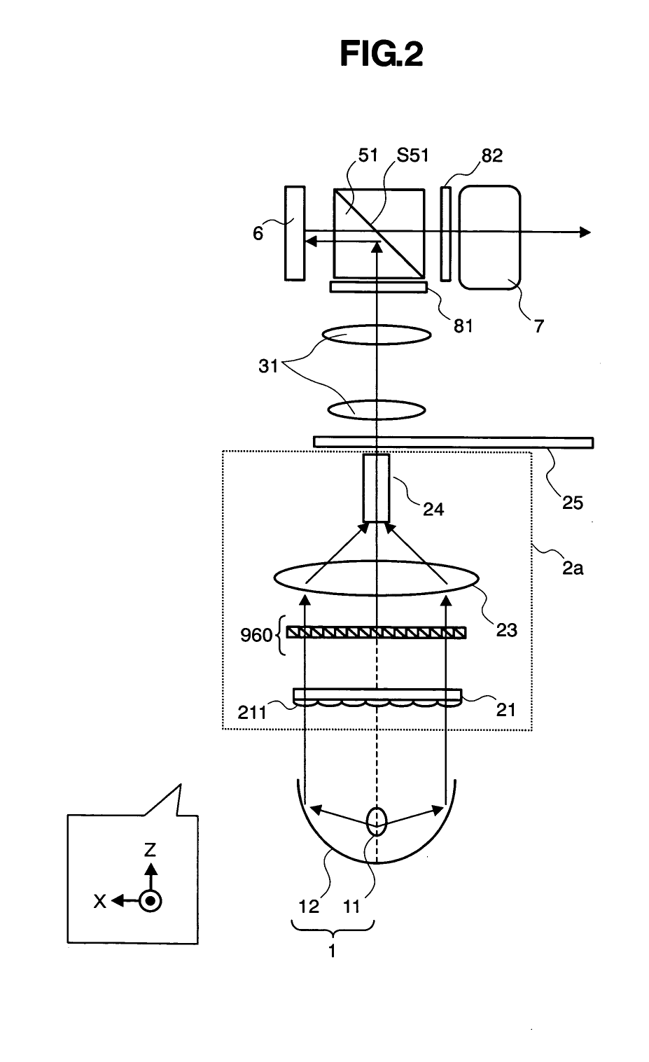

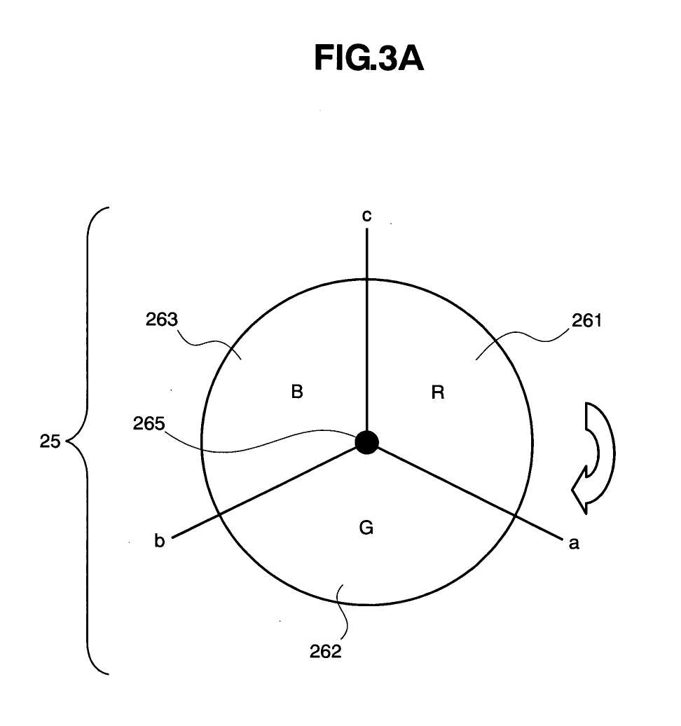

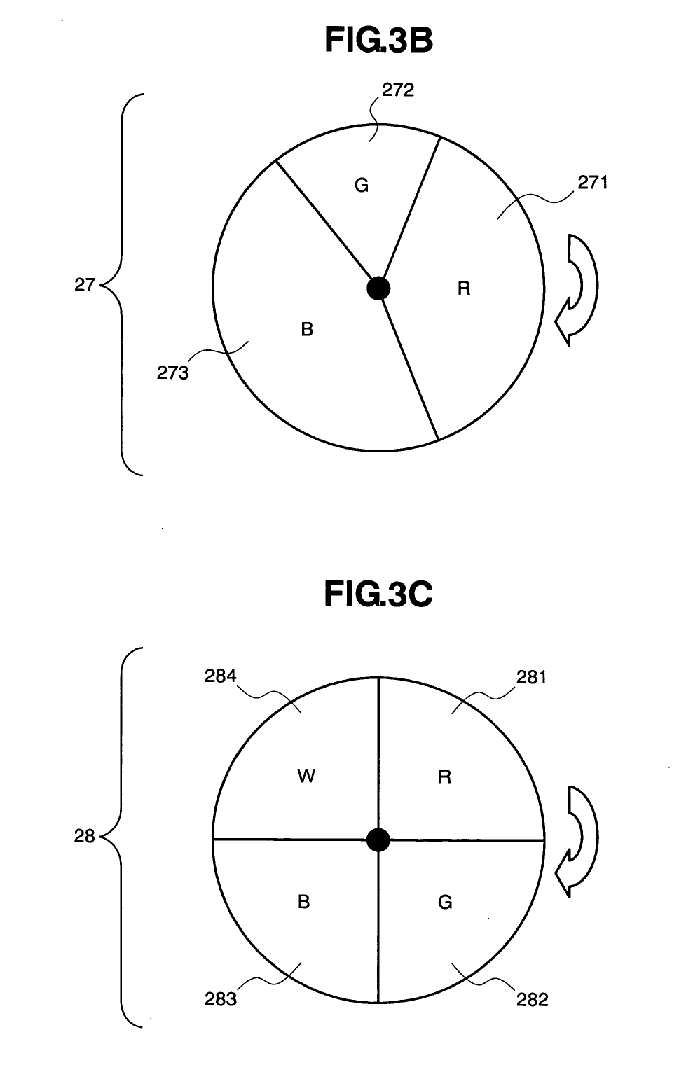

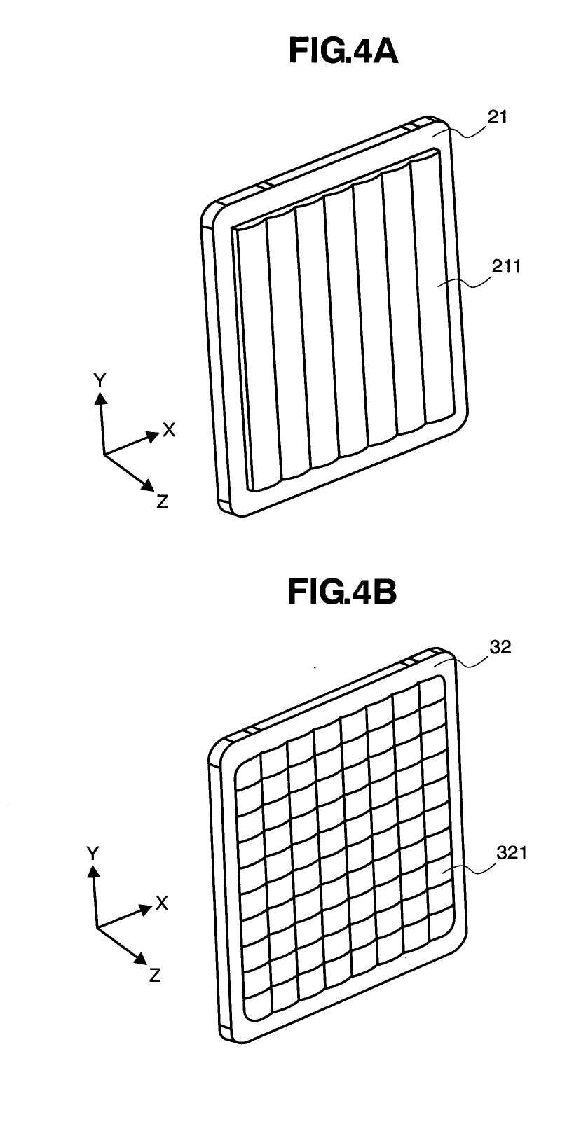

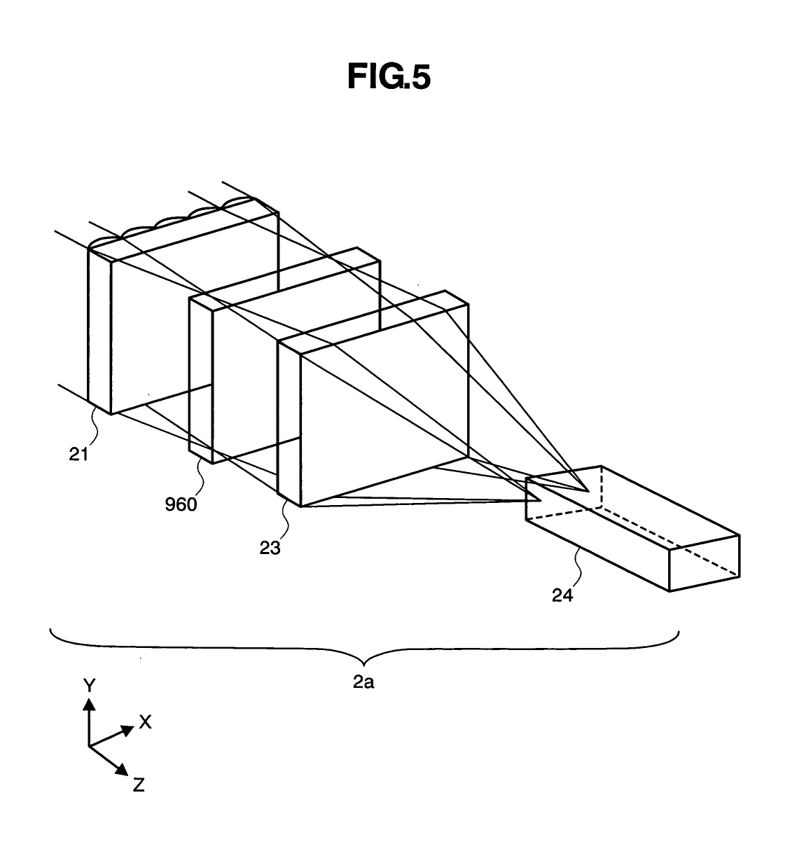

The following explains a projection type image display apparatus including a polarization converter unit according to Embodiment 1 with reference to FIG. 1, FIG. 5, FIG. 4, FIG. 2, and FIG. 3. First, the following explains a single-plate projection type image display apparatus mounting a polarization converter unit according to Embodiment 1 with reference to FIG. 2. Before explanation, a right-handed rectangular coordinate system is introduced in FIG. 2 in order to facilitate the following illustrations. Specifically, an optical axis direction of a light source unit 1 is the Z axis, an axis which intersects perpendicularly to the paper surface and comes from the back side to the front side of the paper is the Y axis, and an axis which intersects perpendicularly to the YZ plane defined by the Y and Z axes is the X axis. For convenience of explanation, a direction in parallel with the X axis is referred to as the X direction and a direction in parallel with the Y axis is referred to as the Y direction.

In FIG. 2, the light source unit 1 includes a light source 11 and a reflector 12 (a parabolic reflector in this diagram). The light emitted from the light source 11 is reflected by the reflector 12, and substantially parallel light beam is emitted from the light source unit 1 and then enter a polarization converter unit 2a.

The polarization converter unit 2a includes, sequentially from the incidence side, a cylindrical lens array 21, a polarization conversion element 960, a condenser lens 23, and a rod integrator 24. The cylindrical lens array 21 arranges a plurality of cylindrical lens cells 211 for splitting the light beam emitted from the light source unit 1 into a plurality of partial light beams. The polarization conversion element 960 aligns the polarizing direction of a plurality of partial light beams split by the cylindrical lens array 21 in a predetermined polarizing direction. The rod integrator 24 has action of making the light volume distribution uniform. The polarization conversion element 960 splits the light emitted from the light source into a plurality of partial light beams and then subjects the light beams to polarization conversion. Then, the rod integrator 24 uniforms the light volume distribution. An image on the light-exiting side end face of the rod integrator 24 is mapped on a reflection type image display element 6 formed of, for example, reflection type liquid crystal by a map optical system 31 mentioned later. Therefore, the shape of the light-exiting side end face of the rod integrator 24 is to be analogous to that of the reflection type image display element 6.

The light coming from the polarization converter unit 2a enters a color wheel 25, rotating color separation means, and then undergoes time-sequential color separation into three different color lights (the R light, G light, and B light). The color wheel 25 arranged on the light-exiting side of the rod integrator 24 is a thin disc, as shown in FIG. 3A. FIG. 3A shows the configuration of the color wheel. This disc is split into a plurality of fan-shaped sections (three sections in this case). A color separation section is formed in each fan-shaped section. The color separation section transmits light in a predetermined wavelength band, among incident lights, while reflecting lights in other wavelength bands, resulting in color separation of the light in the predetermined wavelength band. The color wheel 25 rotates about a rotational axis 265 to perform time-sequential color separation of the incident light into a plurality of lights (the R light, G light, and B light) in predetermined wavelength bands.

The plurality of color separation sections are composed of a red-light transmission dichroic mirror 261, a green-light transmission dichroic mirror 262, and a blue-light transmission dichroic mirror 263. The red-light transmission dichroic mirror 261 transmits only the R light and reflects other color lights. The green-light transmission dichroic mirror 262 transmits only the G light and reflects other color lights. The blue-light transmission dichroic mirror 263 transmits only the B light and reflects other color lights. Line a indicates a boundary line between the red-light transmission dichroic mirror 261 and the green-light transmission dichroic mirror 262. Line b indicates a boundary line between the green-light transmission dichroic mirror 262 and the blue-light transmission dichroic mirror 263. Line c indicates a boundary line between the red-light transmission dichroic mirror 261 and the blue-light transmission dichroic mirror 263.

Returning to FIG. 2, the light beam coming from the color wheel 25 penetrates through the map optical system 31, with the purity of polarizing condition improved by a polarizing plate 81 which transmits the light polarized in a predetermined direction, and then enters a polarization beam splitter (hereafter referred to as PBS) 51 which is a polarization split element. The polarizing direction of the light beam entering the PBS 51 is to be perpendicular to the incidence plane (ZX plane formed by the incident light and reflected light) (S-polarized). Therefore, the polarizing direction transmitted by the polarizing plate 81 is to be S-polarized. The S-polarized light beam which entered the PBS 51 reflects off a polarization split plane S51 and then enters the reflection type image display element 6 formed of, for example, reflection type liquid crystal. With the light reflecting off each pixel of the reflection type image display element 6, the polarizing condition is converted to P-polarized when each pixel is ON; then, the light penetrates through the PBS 51 and then is projected in magnified form on a screen (not shown), etc., through a projection lens 7. When each pixel is OFF, the polarizing condition remains S-polarized and therefore the light reflects off again the polarization split plane of the PBS 51, and the S-polarized light beam is not projected in magnified form on a screen, etc. Reference numeral 82 denotes a polarizing plate which transmits P-polarized light.

The following explains the polarization converter unit in detail with reference to FIG. 1. FIG. 1 shows an example of polarization converter unit.

The polarization converter unit 2a in FIG. 1 includes, sequentially from the incidence side, a cylindrical lens array 21 (light-beam split means for splitting the light from the light source unit into a plurality of partial light beams), a polarization conversion element 960 which alignes the polarizing direction in a predetermined polarizing direction, a condenser lens 23, and a rod integrator 24 having action of making the light volume distribution uniform. This polarization converter unit performs polarization conversion for aligning the polarizing direction of the light from the light source unit 1 in a predetermined direction and uniformization of the light volume distribution.

As shown in FIG. 4A, the cylindrical lens array 21 of the polarization converter unit 2a is formed by a plurality of cylindrical lens cells 211 with a cylindrical cross section, extending in the Y direction, which are arranged along the X direction. Therefore, the cylindrical lens array 21 splits the light emitted from the light source unit 1 into a plurality of partial light beams in the X direction and has condensing action in the X direction.

The polarization conversion element 960 includes a light mask 962, a polarization beam splitter array 964, and a λ/2 phase-difference plate 966. The light mask 962 is configured such that striped mask sections 962b and opening sections 962a extending in the Y direction are arranged alternately in plates along the X direction. The polarization beam splitter array 964 is formed of, for example, a composite of a plurality of columnar glass substrates 964c (intersecting perpendicularly to the XZ plane), having a substantially parallel quadrilateral cross section, elongating in the Y direction. Polarization separation films 964a and reflective films 964b are formed alternately at the boundary of each glass substrate 964c. The λ/2 phase-difference plate 966 is configured such that striped opening layers 966a and λ/2 phase-difference layers 966b extending in the Y direction are arranged alternately along the X direction.

The condenser lens 23 is installed between the polarization conversion element 960 and the rod integrator 24. The rod integrator 24 is a rod lens having a columnar structure made of, for example, an optically transparent material (for example, glass material) with a substantially rectangular cross section, being installed on the light-exiting side of the condenser lens 23. The shape of the cross section of the rod integrator 24 is to be substantially analogous to that of the reflection type image display element 6.

Substantially white natural light (unpolarized light without polarization) which entered the cylindrical lens array 21 from the light source unit 1 is split into partial light beams in the X direction by a plurality of cylindrical lens cells 211. The partial light beams coming from the cylindrical lens array 21 enter the polarization conversion element 960. In other words, the cylindrical lens array 21 functions as light-beam split means.

Each of partial light beams from the cylindrical lens array 21, which entered the polarization conversion element 960, passes through the corresponding opening section 962a of the light mask 962 and then enters the polarization split film 964a. The polarization separation film 964a reflects S-polarized light of partial light beams entered and transmits P-polarized light thereof, to thereby perform polarization split into S-polarized light and P-polarized light. Then, the S-polarized light which reflected off the polarization split film 964a reflects off a paired reflective film 964b (reflective film on the positive side in the X direction of the above-mentioned polarization split film 964a) and then exits from the opening layer 966. On the other hand, the P-polarized light which penetrated through the polarization split film 964a is converted to S-polarized light having an orthogonal polarizing direction by the λ/2 phase-difference layer 966b. Thus, partial light beams (S-polarized light) with a polarizing direction aligned in a substantially fixed direction exit from all pairs of the polarization split film 964a and reflective film 964b of the polarization conversion element 960, and then enter the condenser lens 23. Each of partial light beams which entered the condenser lens 23 is superposed by it at the incidence opening of the rod integrator 24.

For the light which entered the rod integrator 24, the light volume distribution is uniformed by repeating total reflection on the side faces of the rod integrator 24. Then, the light having a uniform light volume distribution enters the color wheel 25 from the light-exiting side end face whose shape is analogous to that of the reflection type image display element 6 of the rod integrator 24. An image on the light-exiting side end face of the rod integrator 24 is mapped on the reflection type image display element 6 by the map optical system 31.

The following explains the arrangement direction of the cylindrical lens array 21 and rod integrator 24 with reference to FIG. 5. FIG. 5 is a schematic lighting diagram illustrating the light condensing action of the polarization converter unit.

Light which entered each cylindrical lens 211 of the cylindrical lens array 21 from the light source unit 1 is refracted in the X direction along which cylindrical lenses are arranged, and then advances substantially in parallel in the Y direction. Therefore, the shape of the light condensed near the incidence-side end face of the rod integrator 24 by the condenser lens 23 tends to become larger in the X direction than in the Y direction. On the other hand, it is necessary to make the shape of the rod integrator 24 analogous to that of the image display element used. Accordingly, it is necessary to make the shape of the incidence-side end face and light-exiting side end face rectangular. Therefore, by matching the arrangement direction (X direction) of the cylindrical lens array 21 and the long side direction of the cross section of the rod integrator 24, the rod integrator 24 can efficiently capture light.

As mentioned above, with the polarization converter unit in FIG. 1, it is not necessary to make the shape of the cylindrical lens cell 211 analogous to that of the image display element. Therefore, there is degree of freedom for adjusting the shape so that as large quantity as possible of each partial light beam exiting from the cylindrical lens array 21 passes through the opening section 962a of the light mask 962 of the polarization conversion element 960. Thus, eclipse of the partial light beams exiting from the cylindrical lens array 21, caused by the light-shielding face 962b of the light mask 962, is reduced by adjusting the shape of the cylindrical lens cell 211, thereby improving the utilization efficiency of light in comparison with the prior art.

The light coming from the cylindrical lens array 21 is condensed near the incidence-side end face of rod integrator 24 by the condenser lens 23. Therefore, since each lens cell of the second lens array and the condenser lens form the image of each lens cell of the first lens array on the image display element, it is not necessary to adjust the shape of the cylindrical lens cell 211 with high precision, resulting in reduced cost.

Since the light split into a plurality of light beams by a plurality of cylindrical lens cells 211 enters the polarization conversion element 960, temperature rise at the incidence portion of the polarization conversion element 960 does not become remarkable, resulting in a small loss of the polarization conversion efficiency accompanying temperature rise.

Since light-beam split means (the cylindrical lens array 21 in the above description) for splitting the light of the light source into a plurality of light beams is arranged between the light source unit 1 and the rod integrator 24, uniform load of light at the rod integrator 24 arranged on subsequent stages decreases. Accordingly, the length of the rod integrator 24 can be reduced allowing the polarization converter unit 2a to be downsized.

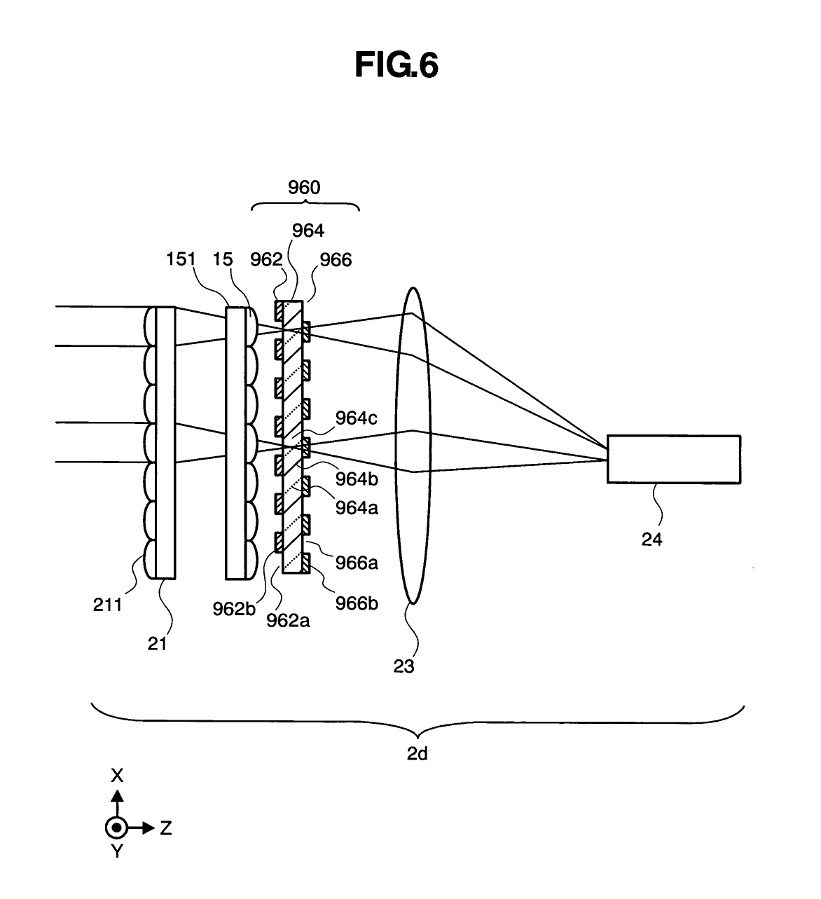

Although the example in FIG. 1 uses one cylindrical lens arrays 21, the present invention is not limited to this configuration. Instead of using one cylindrical lens arrays 21 as mentioned above, two cylindrical lens arrays may be used. The block diagram of a polarization converter unit 2d based on two cylindrical lens arrays is shown in FIG. 6. The cylindrical lens arrays 21 and 15 split the substantially parallel light emitted from the light source (not shown) into a plurality of light beams and then release them. The light split into a plurality of partial light beams passes through the corresponding opening section 962a of the light mask 962 of the polarization conversion element 960 and then enters the polarization split film 964a. Each of a plurality of partial light beams is S-polarized in a predetermined polarizing direction, the S-polarized partial light beams are superposed and then condensed near the incidence-side end face of the rod integrator 24 by use of the condenser lens 23, so that the light volume distribution is uniformed by the rod integrator 24 of a light pipe. In this manner, the thus-formed two cylindrical lenses reduce the aberration of the light entering the polarization conversion element 960. If the aberration of light is reduced, the spot diameter can be reduced resulting in reduced eclipse of the partial light beams coming from the cylindrical lenses 21 and 15, caused by the light-shielding face 962b of the light mask 962, thereby improving the utilization efficiency of light.

Although the example in FIG. 1 uses the cylindrical lens array 21 as light-beam split means, the present invention is not limited to this configuration. For example, a lens array configuration wherein a plurality of lens cells are arranged in matrix form may be used. The block diagram of the lens array is shown in FIG. 4B. Substantially white natural light (unpolarized light without polarization) which entered a lens array 32 is split into a plurality of partial light beams by a plurality of lens cells 321, exits from it, passes through the corresponding opening section 962a of the light mask 962 of the polarization conversion element 960, and enters the polarization split film 964a. Although each lens cell 321 included in the lens array 32 is arranged in matrix form, it is not necessary that its shape be analogous to that of the image display element. Therefore, the shape can be adjusted so that as large quantity as possible of each partial light beam exiting from the lens array 32 passes through the opening section 962a of the light mask 962 of the polarization conversion element 960. Therefore, eclipse of the partial light beams coming from the lens array 32, caused by the light-shielding face 962b of the light mask 962, is reduced, thereby improving the utilization efficiency of light.

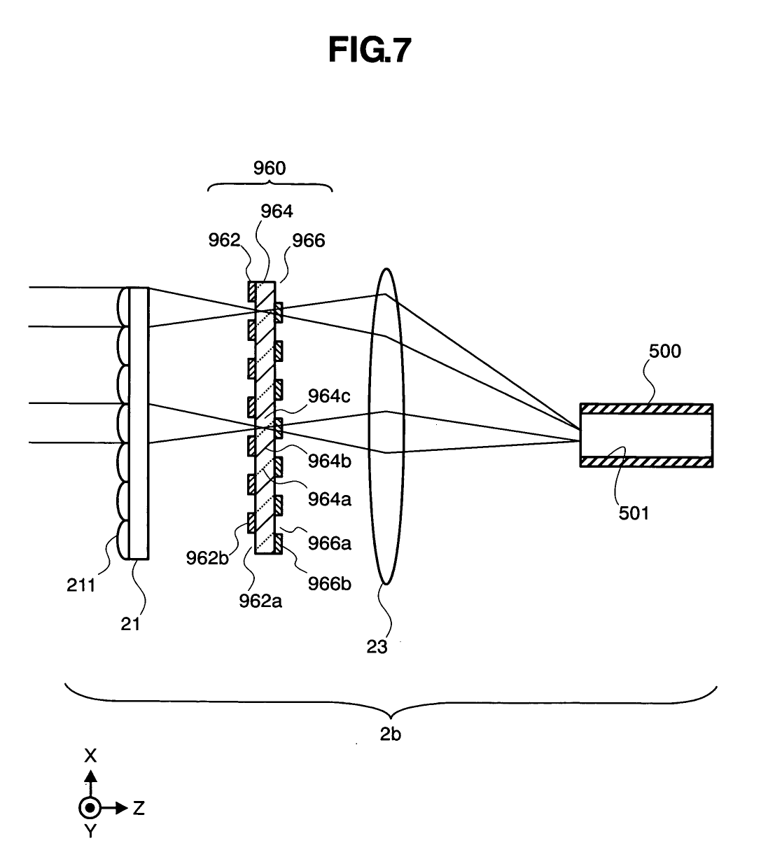

Furthermore, although the example in FIG. 1 uses a rod lens made of a transparent material as the rod integrator 24, a light pipe with a hollow structure wherein reflective mirrors are formed on the inner side faces may be used instead of a rod lens. FIG. 7 shows an example of polarization converter unit using a light pipe as a rod integrator. In FIG. 7, similarly to the operation performed by the above-mentioned polarization converter unit 2a, a polarization converter unit 2b splits the light from the light source unit 1 into a plurality of partial light beams by use of the cylindrical lens array 21; aligns each of a plurality of partial light beams S-polarized in a predetermined polarizing direction by use of the polarization conversion element 960; superposes the S-polarized partial light beams and condenses them near the incidence-side end face of a rod integrator 500 by use of the condenser lens 23; and uniforms the light volume distribution by use of the rod integrator 500. Reflective mirrors 501 are arranged on the inner side faces of the rod integrator 500. The light which entered the rod integrator 500 advances inside it repeating total reflection on the reflective mirrors 501, resulting in uniformed light volume distribution.

Although the example mentioned above uses a straight-type rod integrator wherein the area of the incidence-side end face is the same as that of the light-exiting side end face, the present invention is not limited to this configuration. Since the straight-type rod integrator is not provided with an F-value conversion function, the light angle of the light which entered the rod integrator is conserved. Therefore, when light with a large incident light angle enters the rod integrator, light with a large incident angle exits from the rod integrator 24, degrading the color separation performance of the color wheel 25. In order to improve this performance, it is desirable that the rod integrator 24 be configured so that the area of the incidence-side end face is smaller than that of the light-exiting side end face and that it be provided with the F-value conversion function for reducing the light angle at the light-exiting side end face.

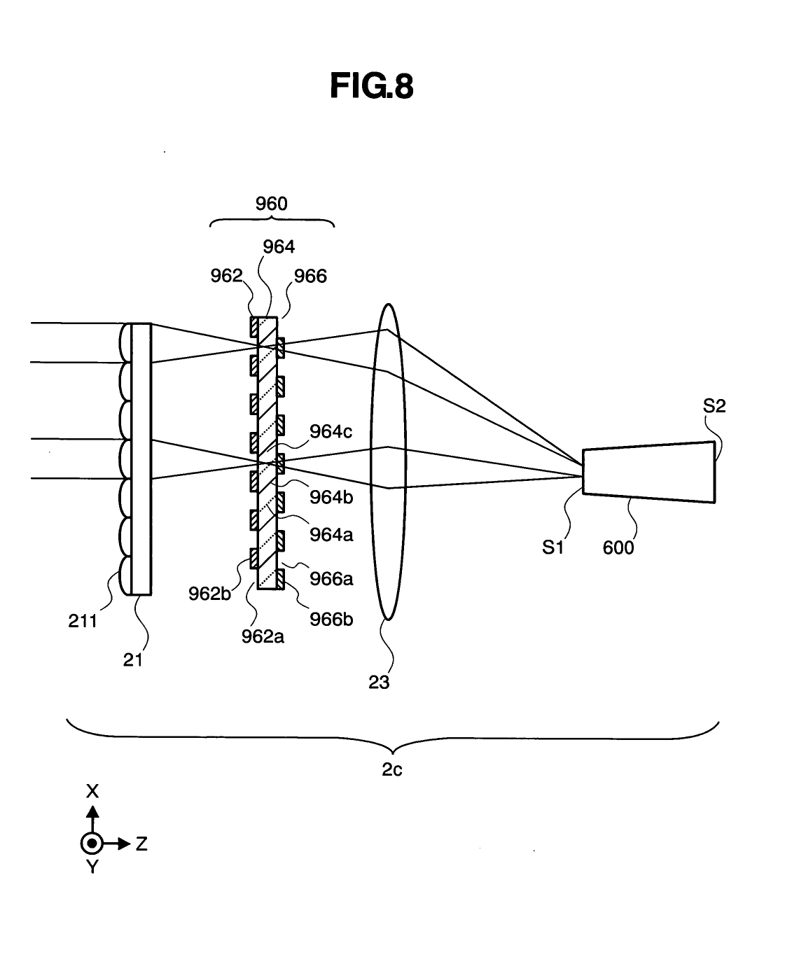

FIG. 8 is a block diagram showing a polarization converter unit using a rod integrator 600 in columnar shape, which is configured so that the area of the incidence-side end face is smaller than that of the light-exiting side end face. In FIG. 8, similarly to the operation performed by the above-mentioned polarization converter unit 2a, a polarization converter unit 2c splits the light from the light source unit 1 into a plurality of partial light beams by use of the cylindrical lens array 21; aligns each of a plurality of partial light beams S-polarized in a predetermined polarizing direction by use of the polarization conversion element 960; superposes the S-polarized partial light beams and condenses them at the incidence-side end face S1 of a rod integrator 600 by use of the condenser lens 23; and uniforms the light volume distribution by use of the rod integrator 600.

The rod integrator 600 has a columnar shapes which is configured so that the area of the incidence-side end face S1 is smaller than that of the light-exiting side end face S2. The light which entered the incidence-side end face S1, with the light angle reduced by repeating reflection, exits from the light-exiting side end face S2. This makes it possible to reduce the light angle of the light beam entering the color wheel 25, improving the color separation performance of the color wheel 25 as well as the polarization split characteristic in a PBS arranged on subsequent stages, thereby realizing high contrast.

In the above-mentioned example, although we explained, as color separation means, a color wheel having a plurality of color separation sections partitioned to perform time-sequential color separation, the present invention is not limited to this configuration. For example, even with a color wheel having a plurality of separation sections partitioned in whorls toward the center of rotation, the above-mentioned polarization converter unit can be suitably applied. Furthermore, for the above-mentioned color wheel 25, the area of each of the red-light transmission dichroic mirror 261, the green-light transmission dichroic mirror 262, and the blue-light transmission dichroic mirror 263 is to be substantially the same. However, the color wheel may be configured so that the area of at least one color light transmission dichroic mirror is different.

FIG. 3B shows a configuration of a color wheel 27 with different areas of transmission sections. In FIG. 3B, a red-light transmission dichroic mirror 271, a green-light transmission dichroic mirror 272, and a blue-light transmission dichroic mirror 273 are color separation sections for transmitting the R light, G light, and B light, respectively, which are pieces of light in a specific wavelength band. Luminance and color adjustments can be performed when the area of at least one color light transmission dichroic mirror out of the red-light transmission dichroic mirror 271, the green-light transmission dichroic mirror 272, and the blue-light transmission dichroic mirror 273 is made different as shown in FIG. 3B.

FIG. 3C shows a configuration of a color wheel 28 having a white-light transmission dichroic mirror 284 which transmits white light. In FIG. 3C, a red-light transmission dichroic mirror 281, a green-light transmission dichroic mirror 282, a blue-light transmission dichroic mirror 283, and a white-light transmission dichroic mirror 284 which transmits white light are sections for transmitting the R light, G light, B light, and W light, respectively, which are pieces of light in a specific wavelength band. Owing to installation of the white-light transmission dichroic mirror 284, in this manner, a bright projection image can be obtained with white light which penetrated through the white-light transmission dichroic mirror 284.

With either example in FIG. 3, although colors subject to color separation are three colors (R, G, and B), a combination of Y (yellow), C (cyan), and M (magenta) may be used. A combination of three or more colors, for example R, G, B, and Y, may also be used. If more than three colors are used in a general xy chromaticity diagram, the chromaticity displayable range, represented by a triangle with three colors, can be represented by a rectangle by increasing the number of colors, resulting in extended range of chromaticity representation. The arrangement of each section of a dichroic mirror is not limited to what is illustrated.

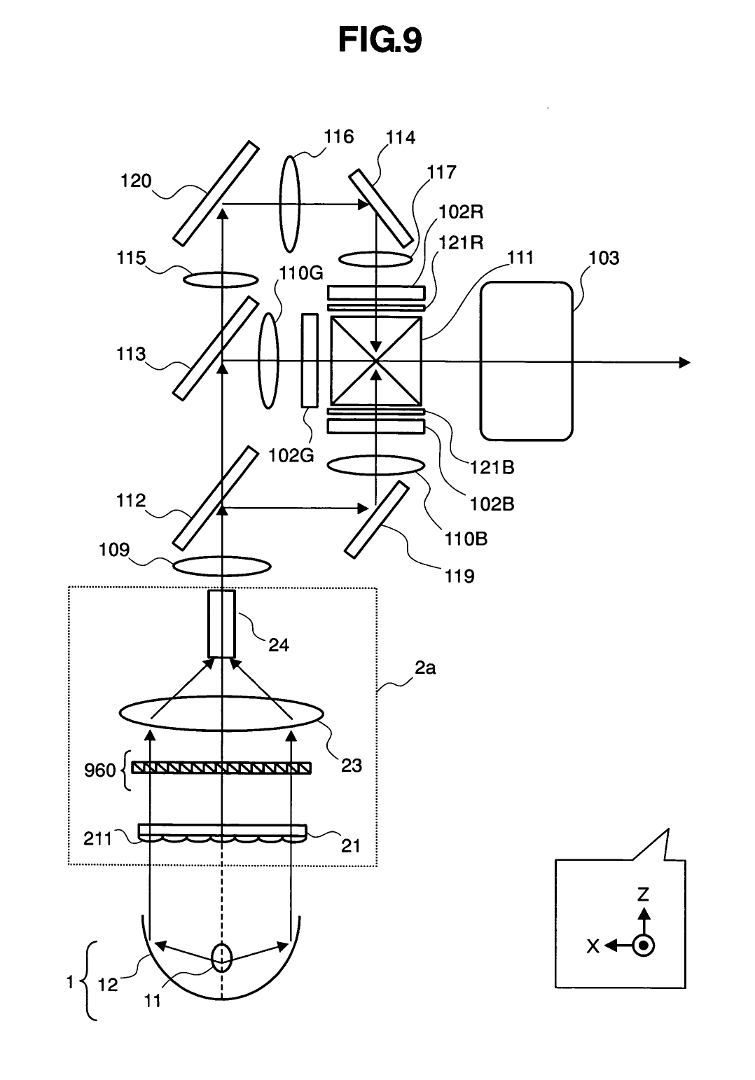

Although the example in FIG. 2 applies the polarization converter unit 2a as a single-plate projection type display apparatus using one reflection type image display element, the present invention is not limited to this configuration. The following explains an example applied to a transmission 3-plate projection type display apparatus using three transmission liquid crystal display elements with reference to FIG. 9. In FIG. 9, the same symbols are assigned to the same elements as in FIG. 1 and FIG. 2 and duplicated explanations are omitted.

In FIG. 9, substantially parallel white light emitted from the light source unit 1 enters the polarization converter unit 2a. The polarization converter unit 2a first splits the light from the light source unit 1 into a plurality of partial light beams by use of the cylindrical lens array 21; aligns each of a plurality of partial light beams S-polarized in a predetermined polarizing direction by use of the polarization conversion element 960; superposes the S-polarized partial light beams and condenses them near the incidence-side end face of the rod integrator 24 by use of the condenser lens 23; and uniforms the light volume distribution by use of the rod integrator 24. An image on the light-exiting side end face of the rod integrator 24 is mapped on each of liquid crystal panels 102R, 102G, and 102B, which are transmission image display elements, by use of a condenser lens 109, condenser lenses 110R and 110B, a first relay lens 115, a second relay lens 116, and a third relay lens 117.

The first relay lens 115, the second relay lens 116, and the third relay lens 117 form a relay lens optical system which compensates for an optical path length extended up to the liquid crystal panel 102R with respect to the optical path length for the liquid crystal panels 102B and 102G. The S-polarized light coming from the polarization converter unit 2a is condensed by the condenser lens 109 and then enters color separation means having a dichroic mirror 112 and a dichroic mirror 113.

The dichroic mirror 112 is provided with a function, for example, to reflect the B light (light in blue band) and transmit the G light (light in green band) and the R light (light in red band) for color separation into two-color light. Furthermore, the G light and R light transmitted are separated into the G light and R light by the dichroic mirror 113. For example, the G light reflects off the dichroic mirror 113 while the R light penetrates through the dichroic mirror 113, resulting in color separation into three-color light. In the example in FIG. 9, the B light reflects off the dichroic mirror 112 and then a mirror 119, penetrates through the condenser lens 110B, and then enters the liquid crystal panel 102B which is a transmission image display element for the B light. Of the G light and R light which penetrated through the dichroic mirror 112, the G light reflects off the dichroic mirror 113, penetrates through the condenser lens 110G, and then enters the liquid crystal panel 102G which is a transmission image display element for the G light. The R light penetrates through the dichroic mirror 113; advances through the relay lens optical system including the first relay lens 115, the second relay lens 116, and the third relay lens 117 with the optical path direction changed by a mirror 120 and a mirror 114; and enters the liquid crystal panel 102R which is a transmission image display element for the R light.

Each of pieces of color light (the R light, G light, and B light) which entered each of liquid crystal panels 102 (102R, 102G, and 102B, respectively) undergoes light intensity modulation with which the polarizing direction rotates based on a picture signal (not shown) in respective liquid crystal panel to form an optical image of the P-polarized light. Optical images of the R light and B light of the P-polarized light are converted to S-polarized light by λ/2 phase-difference plates 121R and 121B, respectively. Then an optical image of the G light of the P-polarized light, as it is, enter a color composition prism 111 formed of a cross dichroic prism. The optical images of the pieces of color light are composed into a color image by the color composition prism 111 and the resultant image is projected in magnified form on a screen (not shown) by a projection lens 103 which is, for example, a zoom lens.

Various types of color separation methods are assumed; for example, the dichroic mirror 112 may reflect the R light and transmit the G light and B light, or it may reflect the G light and transmit the R light and B light. In either case, the arrangement of the transmission image display element is not limited to what is illustrated.

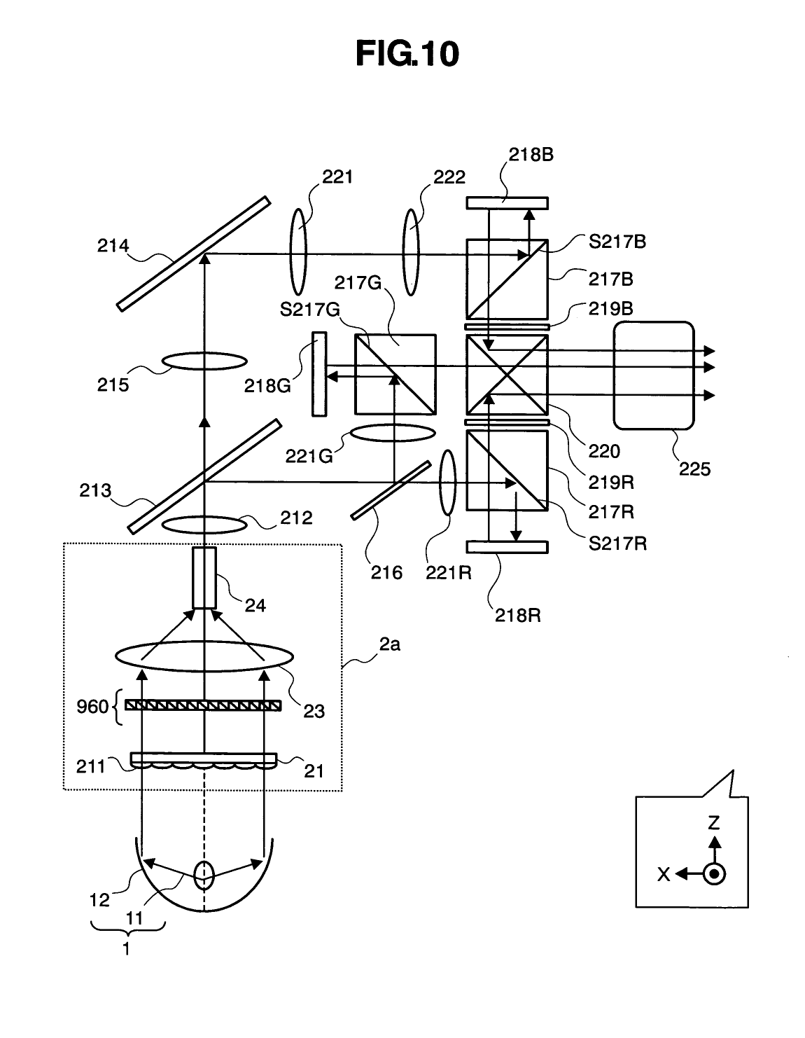

The following explains an example wherein the polarization converter unit 2a is applied to a reflection 3-plate projection type display apparatus using three reflection type liquid crystal display elements with reference to FIG. 10.

In FIG. 10, substantially parallel white light emitted from the light source unit 1 enters the polarization converter unit 2a. The polarization converter unit 2a first splits the light from the light source unit 1 into a plurality of partial light beams by use of the cylindrical lens array 21; aligns each of a plurality of partial light beams S-polarized in a predetermined polarizing direction by use of the polarization conversion element 960; superposes the S-polarized partial light beams and condenses them near the incidence-side end face of the rod integrator 24 by use of the condenser lens 23; and uniforms the light volume distribution by use of the rod integrator 24. An image on the light-exiting side end face of the rod integrator 24 is mapped on liquid crystal panels 218R, 218G, and 218B which are reflection type image display elements, by use of a condenser lens 212, condenser lenses 221R and 221G, a first relay lens 215, a second relay lens 221, and a third relay lens 222.

The first relay lens 215, the second relay lens 221, and the third relay lens 222 form a relay lens optical system which compensates for an optical path length extended up to the liquid crystal panel 218B with respect to the optical path length for the liquid crystal panels 218R and 218G. The S-polarized light coming from the polarization converter unit 2a penetrates through the condenser lens 212 and then enters color separation means having a dichroic mirror 213 and a dichroic mirror 216.

The dichroic mirror 213 transmits the B light and reflects the G light and R light, resulting in color separation into two-color light. Furthermore, the G light and R light transmitted are split into the G light and R light by the dichroic mirror 216. Specifically, the G light reflects off the dichroic mirror 216 while the R light penetrates through the dichroic mirror 216, resulting in color separation into three-color light. The B light which penetrated through the dichroic mirror 213 advances through the relay lens optical system including the first relay lens 215, the second relay lens 221, and the third relay lens 222 with the optical path direction changed by a mirror 214; and enters a PBS 217B. Since the B light which entered the PBS 217B is S-polarized light, it reflects off a polarization split plane S217B and then enters a liquid crystal panel 218B which is a reflection type image display element for the B light. On the other hand, the R light and G light reflected by the dichroic mirror 213 enter the dichroic mirror 216 with G-light reflection and R-light transmission characteristic, resulting in color separation into reflected G light and penetrating R light.

The R light which penetrated through the dichroic mirror 216 penetrates through a condenser lens 221R and then enters a PBS 217R. Since the R light which entered the PBS 17R is S-polarized light, it reflects off a polarization split plane S217R and then enters a liquid crystal panel 218R which is a reflection type image display element for the R light. Similarly, the G light which reflected off the dichroic mirror 216 penetrates through a condenser lens 221G and then enters a PBS 217G. The G light which entered the PBS 217G reflects off a polarization split plane S217G and then enters a liquid crystal panel 218G which is a reflection type image display element for the G light.

Each of pieces of color light (the R light, G light, and B light) which entered each of liquid crystal panels 218 (218R, 218G, and 218B, respectively) which are reflection type image display elements arranged for each color light exits from the panel with the polarizing condition converted to P-polarized when each pixel of each liquid crystal panel is ON; then, each of pieces of color light coming from each of liquid crystal panels 218 penetrates through each PBS 217 (217R, 217G, and 217B). The R light and B light pass through λ/2 phase-difference plates 219 (219R and 219B, respectively) which convert the polarizing direction, with conversion from P-polarized light to S-polarized light, and then enters a color composition prism 220 formed of a cross dichroic prism. Each color light undergoes color composition as color light by use of the color composition prism 220 and then is projected in magnified form on a screen (not shown) through a projection lens 225.

Various types of color separation methods are assumed; for example, the dichroic mirror 213 may transmit the R light and reflect the G light and B light, or it may transmit the G light and reflect the R light and B light. In either case, the arrangement of the reflection type image display element is not limited to what is illustrated.

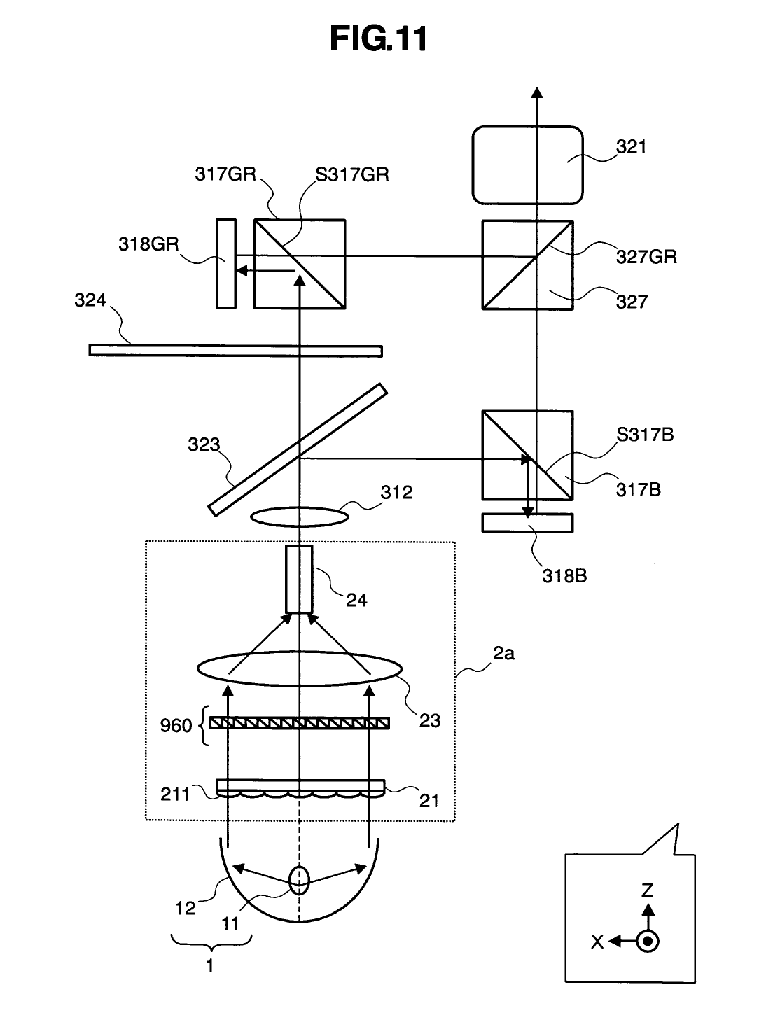

The following explains an example wherein a polarization converter unit 2a is applied to a reflection 2-plate projection type image display apparatus using two reflection type liquid crystal display elements with reference to FIG. 11.

In FIG. 11, substantially parallel white light emitted from the light source unit 1 enters the polarization converter unit 2a. The polarization converter unit 2a first splits the light from the light source unit 1 into a plurality of partial light beams by use of the cylindrical lens array 21; aligns each of a plurality of partial light beams S-polarized in a predetermined polarizing direction by use of the polarization conversion element 960; superposes the S-polarized partial light beams and condenses them near the incidence-side end face of the rod integrator 24 by use of the condenser lens 23; and uniforms the light volume distribution by use of the rod integrator 24. Then, an image on the light-exiting side end face of the rod integrator 24 is mapped through a condenser lens 312 on each of liquid crystal panels 318GR and 318B which are reflection type image display elements.

The S-polarized light coming from the polarization converter unit 2a passes through the condenser lens 312 and then enters a dichroic mirror 323, first color separation means. The dichroic mirror 323 transmits the R light and G light and reflects the B light, resulting in color separation into two-color light. Various types of color separation methods are assumed; for example, the dichroic mirror 323 may transmit the R light and reflect the G light and B light, or it may transmit the G light and reflect the R light and B light. The present embodiment assumes a case where the dichroic mirror 323 reflects the B light and transmits the G light and R light. The B light which reflected off the dichroic mirror 323 enters a PBS 317B, reflects off a polarization split plane S317B, and then enters the liquid crystal panel 318B which is a reflection type image display element for the B light.

Mixed-color light of the G light and R light which penetrated through the dichroic mirror 323 enters a color wheel 324, second color separation means, and then undergoes time-sequential color separation into the G light and R light by the color wheel 324. The color wheel 324, having a dichroic film section (not shown) with G-light transmission and R-light reflection characteristic and a dichroic film section (not shown) with G-light reflection and R-light transmission characteristic on a disc-shaped substrate, rotates around the central axis of a disc (not shown). When the color wheel 324 rotates, the G light and R light exit from it alternately. The G light and R light, after time-sequential color separation, enter the PBS 317GR, reflect off a polarization split plane S317GR, and then enter the liquid crystal panel 318GR which is a reflection type image display element.

The B light which entered the liquid crystal panel 318B exits from it with the polarizing condition converted to P-polarized when each pixel of the liquid crystal panel 318B is ON; then, the B light penetrates through a PBS 317B and then enters a dichroic prism 327 included in a color composition system. Furthermore, the G light and R light which entered the liquid crystal panel 318GR on a time-sequential basis exit from it with the polarizing condition converted to P-polarized when each pixel of the liquid crystal panel 318GR is ON; then, the G light and R light penetrate through the PBS 317GR on a time-sequential basis and then enter the dichroic prism 327 of the color composition system.

A dichroic film 327GR with G- and R-light reflection and B-light transmission characteristic is arranged inside the dichroic prism 327. Therefore, the B light which entered the dichroic prism 327 penetrates through the dichroic film 327GR while the G light and R light are reflected. In this manner, color composition is performed for the B light and G/R light displayed on a time-sequential basis. Then, the resultant light is projected on a screen (not shown) through a projection lens 321.

In the example in FIG. 11, the dichroic mirror 323 performs color separation into the B light and a mixed-color light of the G light and R light. However, the mirror may reflect a mixed light of the B light and cyan light, or yellow light, or magenta light and transmit a mixed light of the G light and R light to perform color separation. In a general xy chromaticity diagram, the chromaticity displayable range, represented by a triangle with three-color, can be represented by a rectangle by increasing the number of colors, resulting in extended range of chromaticity representation. The arrangement of each section of a dichroic mirror is not limited in particular.

The above-mentioned embodiment can improve the utilization efficiency of light and provide a high-luminance projection type image display apparatus.

What is claimed is:

1. A projection type image display apparatus, comprising:
a light source;
an optical element which splits light emitted from the light source into a plurality of light beams;
a plurality of polarization split elements which convert the split light beams to light polarized in a predetermined direction;
a rod integrator which inputs the polarized light coming from each of the plurality of polarization split elements;
a liquid crystal display element which forms an optical image using the polarized light from the rod integrator; and
a projection lens which projects the optical image.

2. A projection image display apparatus according to claim 1, wherein
the optical element has a plurality of lenses arranged in a first direction, the plurality of lenses irradiating at least one of the plurality of polarization split elements with the split light, and
the plurality of polarization split elements are arranged in the first direction.

3. A projection image display apparatus according to claim 2, wherein
the rod integrator has a rectangular incidence side face having a long side in the first direction.

4. A projection image display apparatus according to claim 1, wherein
the optical element has a plurality of lenses arranged in a first direction, the plurality of lenses irradiating at least one of the plurality of polarization split elements with the split light, and
the plurality of polarization split prisms are arranged at least in the first direction.

5. A projection image display apparatus according to claim 1, wherein
the rod integrator has a light-exiting side face whose shape is analogous to that of the liquid crystal display element.

6. A projection image display apparatus according to claim 4, wherein
the shape of the light-exiting side face is rectangular having a long side in the first direction, and
the optical element includes a plurality of cylindrical lenses arranged in the first direction.

7. A projection image display apparatus, comprising:
a light source,
an image display element which forms an optical image from irradiation light;
a projection lens which projects the optical image;
a lens array which splits light emitted from the light source into a plurality of light beams;
a polarization converter unit having a plurality of incidence surfaces which input the light beams split by the lens array and a plurality of light-exiting surfaces which release light polarized in a predetermined direction;
a rod integrator which inputs the polarized light coming from the plurality of light-exiting surfaces, the rod integrator having a light-exiting surface whose shape is analogous to that of the image display element; and
a map optical system which maps the light coming from the rod integrator on the liquid crystal display element.

8. A projection image display apparatus according to claim 7, wherein
the lens array includes a plurality of cylindrical lenses arranged along a first direction.

9. A projection image display apparatus according to claim 8, wherein
the light-exiting surface is a rectangle having a long side in the first direction.

10. A projection image display apparatus according to claim 7, wherein
the lens array includes a plurality of lens cells arranged in matrix form.

11. A projection image display apparatus according to claim 7, wherein
the plurality of incidence surfaces are arranged alternately with a plurality of mask sections in the first direction.

12. A projection image display apparatus according to claim 7, wherein
the rod integrator has an incidence surface whose shape is analogous to that of the light-exiting surfaces and whose area is smaller than that of the light-exiting surfaces.

13. A projection image display apparatus comprising:
a light source;
an image display element which forms an optical image from irradiation light;
a projection lens which projects the optical image;
a plurality of cylindrical lenses arranged in a first direction;
a plurality of polarization beam splitters arranged in the first direction, each of the plurality of polarization beam splitters having an incidence surface which inputs the light from at least one of the a plurality of cylindrical lenses and a light-exiting surface which releases the input light as light polarized in a predetermined direction;
a condenser lens which condenses each light coming from the polarization beam splitters;
a rod integrator which inputs the light from the condenser lens, the rod integrator including a light-exiting surface having a long side in the first direction and a shape analogous to that of the image display element; and
a map optical system which maps the light coming from the rod integrator on the liquid crystal display element.
